(19) United States
(12) Patent Application Publication
(10) Pub. No.: US 2015/0044382 A1
(43) Pub. Date: Feb. 12, 2015

(54) METHOD OF IMPREGNATING CERAMIC CORES FOR THE MANUFACTURE OF TURBOMACHINE BLADES

(71) Applicant: SNECMA, Paris (FR)

(72) Inventor: Chantal Sylvette Langlois, Franconville (FR)

(73) Assignee: SNECMA, Paris (FR)

(21) Appl. No.: 14/384,556

(22) PCT Filed: Mar. 12, 2013
(86) PCT No.: PCT/FR13/50521

§ 371 Date: Sep. 11, 2014

(30) Foreign Application Priority Data
Mar. 16, 2012 (FR) 1252404

(51) Int. Cl. F01D 5/28; C04B 41/48; C04B 41/45

(52) U.S. Cl. CPC F01D 5/286; C04B 41/4535; C04B 41/4869
USPC 427/393.6

(57) ABSTRACT

Impregnation method for mechanically reinforcing a ceramic core used in the manufacture of turbomachinery components by the lost wax casting method, involving dipping the core into a mixture obtained by dissolving polyvinyl alcohol in water, followed by an immersing of the core in pure water and hot polymerization, characterized in that the dosage is between 100 and 200 g of PVAl per litre of water. The dipping impregnation time is preferably between 20 min and 1 h 30.

The field of the present invention is turbine engines and, more specifically, that of the manufacture of metal blade assemblies for these turbine engines.

In order to manufacture parts such as metal blade assemblies for turbine engines, which have internal cavities with complex geometry, the technique known as lost-wax casting is normally used. This consists of producing an initial model of the part in wax or another equivalent material, which can easily be eliminated afterwards.

The manufacturing process begins with the production of an internal part forming a foundry core and including the internal cavities of the blade assembly. Then the wax model is made, using an injection mould into which the core is placed and the wax is injected. A ceramic shell is then created around this model, the shell consisting of a plurality of layers produced by successive dipping in several slurries. The slurries are made up of particles of ceramic material, with a colloidal mineral binder and, where necessary, additives.

The shell mould is then dewaxed, dewaxing being an operation by which the material forming the original wax model is eliminated. After the model has been eliminated, a ceramic mould is obtained, the cavity of which reproduces all the shapes of the blade and which mould still encloses the ceramic core intended to produce the internal cavities of the blade. The mould then undergoes a high-temperature heat treatment or “baking”, which gives it the necessary mechanical properties.

The shell mould is thus ready for the manufacture of the metal part by casting. After the internal and external integrity of the shell mould has been checked, the next step consists in casting a molten metal, which occupies the empty spaces between the internal wall of the shell mould and the core, then solidifying said metal. Finally, after the alloy has been cast, the shell is broken by a shaking-out operation, and then the ceramic core, which remained enclosed in the blade, is eliminated via a chemical treatment and the manufacture of the metal part ends with finishing by machining or polishing.

A problem frequently encountered with ceramic cores is that they have very delicate geometries and they can tend to break or to deform during overmoulding via wax injection. It is therefore necessary to perform a strengthening operation at the end of the manufacturing process. One of the methods currently used consists in filling the porosity of the core using a resin mixed with a diluent, then polymerising this resin, which then enables its mechanical strength to be quadrupled. The products commonly used are a polyepoxide resin, such as Araldite, and a diluent made up of a mixture of solvents, such as toluene and methanol.

The disadvantage with these products is that they are generally toxic (classified as CMR, for carcinogenic, mutagenic or toxic for reproduction) and they require protective measures to be implemented by the operators. Amongst other things, they require, under the [French] Labour Code, the wearing of personal protective equipment and specific monitoring of exposure for each operator, and also that the premises, the suction systems, and the drying means are made compliant with the ATEX (explosive atmospheres) directive.

One solution has been provided by patent application GB2263658 which recommends the use of water as a solvent and of different impregnation products, including polyvinyl alcohol. It recommends concentrations of alcohol within a limit of 10%, in other words, of approximately 10 grams per litre of water, and considers that this concentration is a limit value which is not to be exceeded because the product then becomes too viscous.

The applicant wondered about this limit and wanted to know whether higher concentrations might further improve the situation, and to analyse the constraints that might arise therefrom.

The aim of the present invention is to propose a product that performs better than the current products for mechanical reinforcement of cores, and which complies with the obligations as regards protection of the health and safety of staff and protection of the environment.

To that end, the subject matter of the invention is a method of impregnation for mechanically reinforcing a ceramic core used in the manufacture of turbine engine parts by lost-wax casting, comprising dipping the core in a mixture obtained by dissolving polyvinyl alcohol PVAl in water followed by immersing the core in pure water and hot polymerisation, characterised in that the mixture proportion is between 100 and 200 g of PVAl per litre of water.

Advantageously, the time for impregnation by dipping is between 20 minutes and 1 hour 30 minutes. A long time is necessary for the impregnation product to properly penetrate the pores of the ceramic core, because of its relatively high viscosity.

Preferably, the polymerisation takes place at a temperature of between 90° C. and 120° C.

More preferably, the polymerisation takes place for a period of time of between 30 minutes and 2 hours.

The invention also relates to a method for manufacturing, by lost-wax casting, turbine engine blades with internal cavities, said method comprising a step of producing a ceramic core representing said internal cavities, characterised in that it includes a step of mechanically reinforcing said core via a method as described above.

The invention will be better understood, and its other aims, details, features and advantages will become more clearly apparent on reading the detailed explanatory description given below, of an embodiment of the invention given as a purely illustrative and non-restrictive example, with reference to the accompanying diagrammatic drawings. In these drawings:

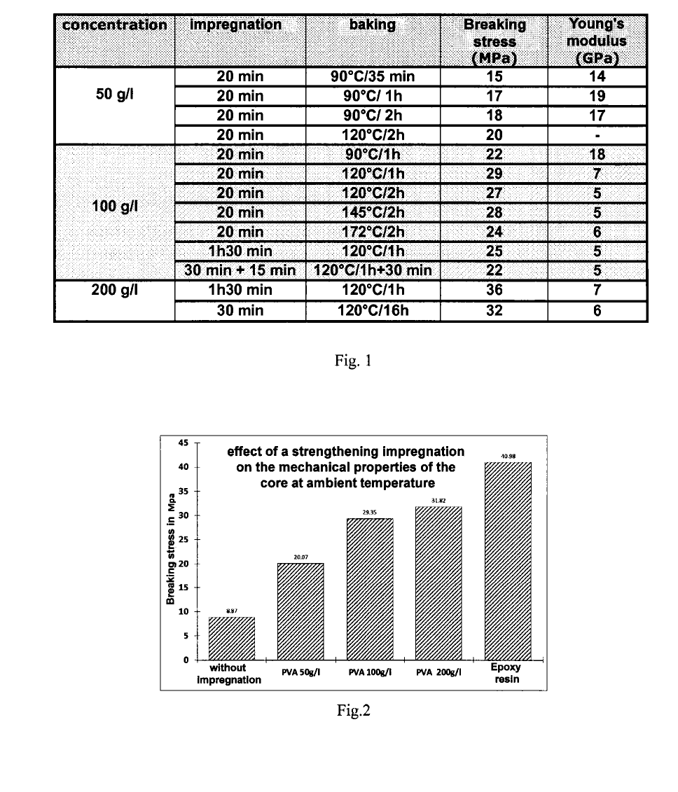

FIG. 1 is a table giving the results obtained by impregnating a blade core with a product according to the invention;

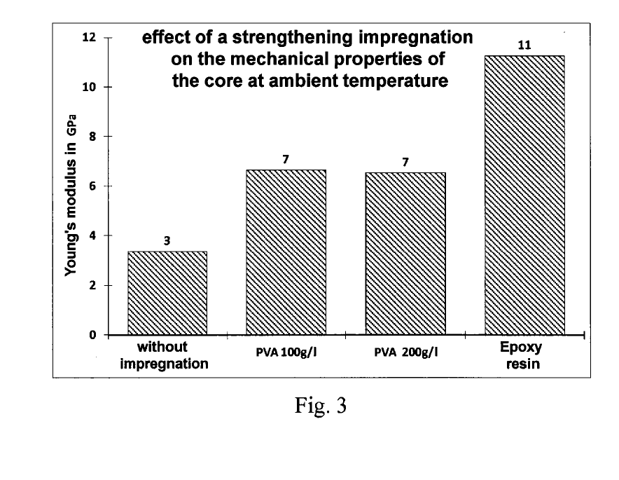

FIGS. 2 and 3 are comparative diagrammatic views of two physical properties of a material obtained using an impregnation product according to the invention and using a product of the prior art.

FIG. 1 shows the results obtained, for various concentrations of polyvinyl alcohol (PVAl) in water and for various manufacturing conditions (impregnation time and baking time and temperature), from a test piece representative of the core of a wax model of a turbine engine blade.

The selected concentrations in alcohol were 50 g/l, 100 g/l and 200 g/l and the impregnation times for the test piece ranged from 20 minutes to 1 hour 30 minutes. In parallel, the baking times and temperatures ranged, respectively, from 35 minutes to 1 hour 30 minutes, with one instance of 16 hours, and from 90° C. to 172° C. It will be noted that:
at a concentration of 50 g/l, with an impregnation time of 20 minutes and baking at a temperature of from 90° C. to 120° C. for 35 minutes to 2 hours, the breaking stress obtained ranged from 14.87 to 20.07 MPa and the Young's modulus ranged from 13.9 to 16.87 GPa.
at a concentration of 100 g/l, with an impregnation time ranging from 20 minutes to 1 hour 30 minutes and baking at a temperature of between 90° C. and 172° C. for 1 to 2 hours, the breaking stress ranged from 21.52 to 29.4 MPa and the Young's modulus ranged from 50.3 to 18.11 GPa.
at a concentration of 200 g/l, with an impregnation time ranging from 30 minutes to 1 hour 30 minutes and baking at a temperature of 120° C. for from 1 to 16 hours, the breaking stress ranged from 31.5 to 35.79 MPa and the Young's modulus ranged from 6.67 to 6.53 GPa.

FIGS. 2 and 3 show, respectively, the breaking stress and the Young's modulus for five types of test piece: a test piece without impregnation, a test piece impregnated with PVAl at a proportion of 50 g/l in water, a test piece impregnated with PVAl at a proportion of 100 g/l, a test piece impregnated with PVAl at a proportion of 200 g/l and a test piece impregnated with epoxy resin according to the prior art.

To address the problem posed, the invention firstly proposes to abandon the use of toluene-or methanol-type diluents of the prior art and to replace them with water, in order to eliminate the risks related to health or to protection of the environment. In order to replace the products of the prior art, a whole series of tests has been performed with different commercial products and different concentrations of water for these products. Different parameters concerning the solution heat treatment of the product (concentration, agitation, temperature) and different drying and polymerisation parameters (temperature, time) have also been evaluated.

In conclusion, the invention selected as the impregnation product polyvinyl alcohol, which is soluble in water and the adhesive and emulsifying properties of which are known. Polyvinyl alcohol, or PVAl, the chemical formula of which is —(CH₂CHOH)n—, is obtained by alkaline hydrolysis (sodium hydroxide, potassium) of polyvinyl acetate. It can be used as a demoulding agent or as a filler and therefore offers the benefit of forming a regular film, which can wrap around a mould and which can therefore be made to wrap around the core for wax models in the case of manufacture of turbine engine blades. This product, which was ultimately preferred after a series of tests conducted on several soluble products with filmogenic properties of coating and adhesion, has the advantage of penetrating into the pores in the surface of the core, filling them and thus creating a shell that is solidified by drying or by polymerisation. Following the tests performed, the recommended concentrations are from 100 to 200 g/l depending on the desired increase in the mechanical properties.

The effect of mechanical reinforcement provided by the product of the invention is therefore dual: it produces a first reinforcement by eliminating part of the porosity, this porosity tending to reduce the mechanical properties of the ceramic material, and a second reinforcement by forming a coating surrounding the core, the coating itself having its own mechanical properties.

The recommended implementation of the invention consists in preparing a mixture by dissolving PVAl in water heated to 80°, in order to accelerate its dissolution. The cores are then immersed in the mixture, and then in distilled water, in order to eliminate the surplus mixture. Finally, they undergo polymerisation in an oven. The gain in mass obtained on the core is around 2%.

A first gain provided by the invention lies in the use of water as a solvent, which eliminates the problems of toxicity encountered with the previous organic solvents. On the other hand, this choice means abandoning standard resins and choosing instead a product such as PVAl, which is soluble in water and polymerisation of which strengthens the core sufficiently. One of the difficulties encountered in developing the invention consisted in being able to concentrate the mixture sufficiently to increase the effectiveness of its mechanical strengthening after polymerisation, while retaining a relatively low viscosity in order to impregnate the core properly.

The results obtained with water and PVAl show (cf. FIGS. 2 and 3) a clear increase in the properties of the material, which, it is true, remain inferior to those obtained with organic solvents of the prior art, but are sufficient for the method for manufacturing cores for turbine engine blades. Thus, it can be seen that, for mixture proportions of approximately 100 g/l to 200 g/l, the breaking strength is multiplied by 3 (as against 4 in the prior art), in comparison with an untreated test piece, and the Young's modulus is multiplied by 2 (as against 4 in the method of the prior art).

It will also be observed, on seeing FIGS. 2 and 3, that the mechanical strength of a ceramic core is further improved by taking the concentration of PVAl beyond 100 g/l. In particular, the gain obtained in the flexural breaking strength is particularly worthwhile inasmuch as these cores are fragile and very difficult to manipulate. It is true that this gain is obtained to the detriment of a greater degree of viscosity, which is, in particular, higher than the limit value recommended by the prior art. It is undeniable that too high a degree of viscosity is detrimental because the phase of cleaning in pure water, which follows impregnation in order to remove the excess product on the cores, is made more difficult. This is because certain surfaces, which are extremely thin and fragile, and from the recesses of which it may be difficult to dislodge the product, should not be worked on excessively. The applicant has therefore observed that beyond 200 g/l, the gain was not justified, given the risks incurred.

Although a higher concentration improves the mechanical strength of the impregnated core, the manufacturing schedule must be adjusted to take this viscosity into account. The product must then remain in contact with the core for longer in order to have time to penetrate deeply below the surface of the core and thus fill the pores properly. The impregnation time has therefore had to be increased to values which are not less than 30 minutes, in comparison with the extremely short times, of around 5 minutes, in the prior art.

In short, the applicant has gone against the teaching of the prior art, which fixed the maximum permitted concentration at 10 g/l, and has observed that it was then possible to further improve the mechanical strength of the cores, provided that an adjustment was made to the manufacturing schedule.

1. A method of impregnation for mechanically reinforcing a ceramic core the method comprising:
dipping the core in a mixture comprising polyvinyl alcohol and water, and
subsequently immersing the core in pure water and polymerizing via hot polymerisation,
wherein:
the mixture comprises between 100 and 200 g of polyvinyl alcohol per litre of water.

2. The method according to claim 1, wherein said dipping lasts for a period of between 20 minutes and 1 hour 30 minutes.

3. The method according to claim 1, wherein the polymerisation takes place at a temperature of between 90° C. and 120° C.

4. The method according to claim 3, wherein the polymerisation takes place for a period of between 30 minutes and 2 hours.

5. A method for manufacturing turbine engine blades with internal cavities, the method comprising:
producing a ceramic core representing the internal cavities,
wherein the core is mechanically reinforced via the method according to claim 1.

6. The method according to claim 1, wherein the core is suitable for manufacturing turbine engine parts via lost-wax casting.

7. The method according to claim 5, wherein the turbine engine is manufactured by lost-wax casting.
